(19) United States
(12) Patent Application Publication
(10) Pub. No.: US 2026/0341008 A1
(43) Pub. Date: Oct. 29, 2026

(54) METHODS AND SYSTEMS FOR PROCESSING SALES ORDERS

(71) Applicant: Accenture Global Solutions Limited, Dublin (IE)

(72) Inventors: Latika AGGARWAL, Gurgaon (IN); Selvakuberan KARUPPASAMY, Chennai (IN); Praveen Thenraj GUNASEKARAN, Chennai (IN); Ritesh Prakash DUBAL, Mumbai (IN); Vinu VARGHESE, Bangalore (IN); Ujjala CHATTOPADHYAY, Bangalore (IN); Neesha VYAS, Jammu (IN); Sreenivas Sekhar JOSYULA, Bangalore (IN); Sreevidya PRASAD, Bangalore (IN); Sougata Kumar DAS, Bangalore (IN); Vijay Deep DUDAM, Bangalore (IN)

(73) Assignee: Accenture Global Solutions Limited, Dublin (IE)

(21) Appl. No.: 19/190,336

(22) Filed: Apr. 25, 2025

(51) Int. Cl. G06V 10/82; G06F 40/284; G06Q 10/087; G06V 10/40; G06V 10/764; G06V 30/10; G10L 15/16; G10L 15/18; G10L 21/0208

(52) U.S. Cl. CPC G06V 10/82; G06F 40/284; G06Q 10/087; G06Q 10/0872; G06V 10/40; G06V 10/764; G06V 30/10; G10L 15/16; G10L 15/18; G10L 21/0208

(57) ABSTRACT

Method, system, and computer-readable storage media for processing an input sales order are disclosed. The input sales order is received and preprocessed for processing the input sales order using one or more pretrained Generative Artificial Intelligence (Gen AI) models. The preprocessed input sales order is analyzed using the one or more pretrained Gen AI models to identify tokens. Further, word formulation and word identification are performed on the preprocessed input sales order by extracting characters from the preprocessed input sales order using the one or more pretrained Gen AI models. The one or more pretrained Gen AI models are trained for handwritten character identification and phonetic character identification. Based on the tokens and results of the performed word formulation and word identification, details from the preprocessed input sales order are extracted.

### TECHNICAL FIELD

Various examples described herein relate generally to method, system, and computer program product for efficiently processing sales orders received from multiple channels and in various formats.

### BACKGROUND

In today's rapidly evolving technological landscape, enterprises are increasingly dependent on advanced solutions for receiving sales orders in order to deliver products and/or services to users. Therefore, the enterprises may employ order management systems for different phases of processing the sales orders, for example, receiving, processing, fulfilling, and servicing the sales orders. However, processing the sales orders received from multiple channels and in various formats may be labor-intensive, error prone, and time consuming.

### SUMMARY

In at least one example, the present disclosure provides a computer-implemented method for processing an input sales order. The method includes receiving the input sales order and preprocessing the input sales order for processing using one or more pretrained Generative Artificial Intelligence (Gen AI) models. The method includes identifying a plurality of tokens from the preprocessed input sales order using the one or more pretrained Gen AI models. The method includes performing word formulation and word identification of the input sales order by extracting characters from the input sales order using the one or more pretrained Gen AI models. The one or more pretrained Gen AI models are trained for handwritten character identification and phonetic character identification. The method includes extracting details from the input sales order based on the plurality of tokens and results of the performed word formulation and word identification of the input sales order.

The present disclosure further describes a system for implementing the method provided herein. The present disclosure also describes a non-transitory computer-readable storage media (CRM) having instructions stored thereon which, when executed by one or more processors of a computing device, cause the computing device to perform operations in accordance with the method described herein.

It is appreciated that method in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment used to execute implementations of the present disclosure.

FIG. 2 depicts an example conceptual architecture of a training engine of a system disclosed in the example environment of FIG. 1, for generating pretrained Generative Artificial Intelligence (Gen AI) models, in accordance with implementations of the present disclosure.

FIG. 3 depicts an example training process flow of training a Graph Neural Network (GNN) model and Graph Convolutional Network (GCN) model for classifying images of sales orders, in accordance with implementations of the present disclosure.

FIG. 4 depicts an example training process flow of training a trajectory identification model to perform written character identification, in accordance with implementations of the present disclosure.

FIG. 5 depicts an example training process flow of training an accent identification model to perform phonetic character identification, in accordance with implementations of the present disclosure.

FIG. 6 depicts an example conceptual architecture of an extraction engine of the system disclosed in the example environment of FIG. 1, for processing an input sales order, in accordance with implementations of the present disclosure.

FIG. 7 depicts an example process flow of tasks performed by a validation and analysis module of the extraction engine disclosed in FIG. 6, in accordance with implementations of the present disclosure.

FIG. 8 is a flow diagram that presents an example computer implemented method for processing the input sales order, in accordance with implementations of the present disclosure.

FIG. 9 depicts an example computer system to implement the system disclosed in the example of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality or acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

With the advancements in digitization techniques, efficient and effective processing of sales orders may be important for an enterprise to successfully facilitate a final delivery to users (e.g., customers). Therefore, the enterprise may employ an existing order management system for processing the sales orders.

The existing order management system may process the sales orders by extracting details (also be referenced as attributes, fields, and/or the like) from the sales orders, validating the extracted details, and inputting the validated details into a resource planning system or platform (e.g., an Enterprise Resource Planning (ERP) system) by creating respective order numbers for the fulfilment of the sales orders. However, increased volumes of the sales orders, and/or reception of the sales orders in a non-standardized format (e.g., reception of the sales orders in unstructured or structured formats), and/or diversity in order sources or channels from which the sales orders have been received may pose limitations for the existing order management system in terms of extracting and validating the details of the sales orders.

For example, the sales orders may be received from the different order sources or channels such as, but are not limited to, a voice call, handwritten notes, printed papers, fax, emails, Electronic Data Interchange (EDI), social media platforms, e-commerce websites, and/or the like, and associated with various formats such as, but are not limited to, structured formats, unstructured formats, and/or the like. In such a scenario, the existing order management system may involve manual processes to extract and validate the details (e.g., contact details of the users, Stock Keeping Unit (SKU) descriptions, pricing details, required quantities or units, and/or the like) from the received sales orders. To illustrate, the existing order management system may allow manual agents to manually extract or record the details of the sales orders by listening to the voice call, or by reviewing the handwritten notes or printed papers or by reviewing the emails or PDFs received in the unstructured formats, which may be time consuming and error prone. Further, the existing order management system may allow the manual agents to validate the extracted details by manually cross-referencing the extracted details, which may result in inaccurate validation and may delay the fulfillment of the orders. In addition, manual extraction and validation of the details of the sales orders may result in errors such as missing sales orders, creating duplicate sales orders, and/or the like.

Therefore, the existing order management system may expend a significant amount of time, human resources, and computing resources (e.g., processing resources, memory resources, communication resources, and/or the like) for processing the orders due to the diverse formats of the sales orders and lack of standardization in the diverse formats of the sales orders. Processing of the orders with the inaccurate validation and the delay may reduce engagement of the users with the enterprise, which may lead to potential loss of orders from the users in future.

Implementations of the present disclosure provide a Large Language Model (LLM), and graph enabled accent and trajectory identification (LGATI) framework for efficiently and effectively processing the sales orders without involving the manual processes and with reduced time, cost, and utilization of the computing resources. The LGATI framework may leverage multi-modal models (e.g., pretrained Generative Artificial Intelligence (Gen AI) models) to process the sales orders by ingesting, unifying, and analyzing the sales orders from the different order sources or channels and in various formats. Such a processing of the sales orders may enable timely fulfillment of the sales orders without involving the manual processes. Further, the LGATI framework may support automated multi-cross validation for validating the details extracted from the sales orders. In addition, the LGATI framework may ensure scalability in the entire end to end processing of the sales orders as well as ensure interpretation of the sales orders including multi-lingual orders.

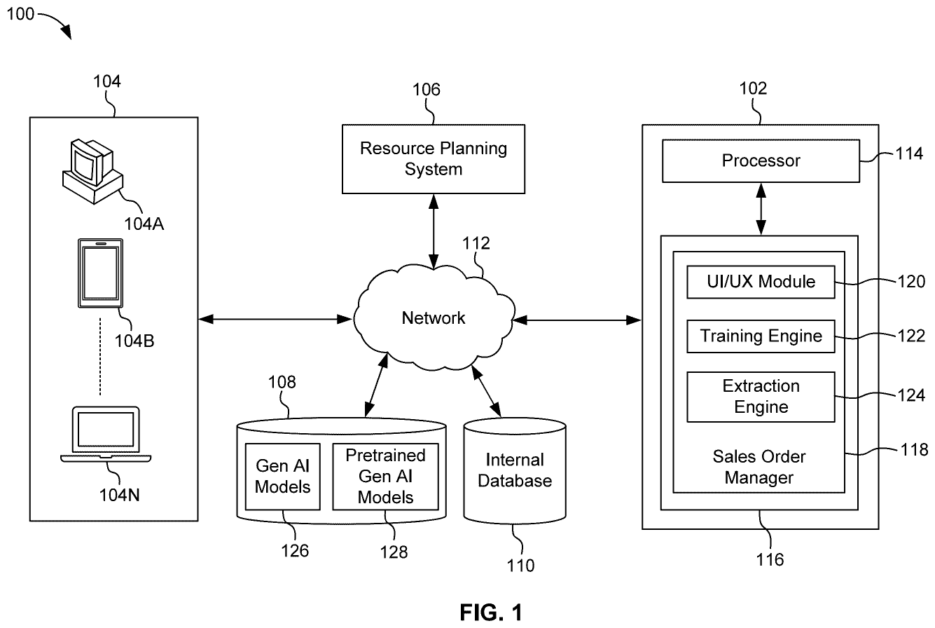

FIG. 1 depicts an example environment 100 used to execute implementations of the present disclosure. The example environment 100 may enable efficient and effective processing of input sales orders. The input sales orders may refer to sales orders received for processing.

The example environment 100, depicted in FIG. 1, includes a system 102, user devices 104A-104N, a resource planning system 106, a model database 108, and an internal database 110. The user devices 104A-104N may be collectively referenced as user devices 104. The system 102 (also be referenced as a multichannel order management system, a multichannel sales order management system, a computing device, and/or the like) may communicate with the user devices 104, the resource planning system 106, the model database 108, and the internal database 110 using a network 112. In some examples, the network 112 may include a Local Area Network (LAN), a Wide Area Network (WAN), the Internet, or a combination thereof. In some examples, the network may be accessed over a wired and/or a wireless communication link.

The user devices 104 may be used by the users (e.g., customers, clients, external entities (e.g., external organizations, external enterprises, and/or the like) to provide the input sales orders to the system 102. Non-limiting examples of the user devices 104 may include desktops, smartphones, laptops, wearable devices, and/or the like. In some examples, the input sales orders may be related to various sectors, for example, but are not limited to, retail industries, healthcare, Information Technology (IT), manufacturing, automotive, communications and media, logistics, or any other suitable sector, wherein delivery of the products and/or the services to be facilitated. By way of non-limiting example, the input sales orders may include work orders, service orders, manufacturing orders, pharmaceutical orders, retail orders, and/or the like. Each of the input sales order may include details (also be referenced as attributes, fields, order values, and/or the like) such as an order number, a product or service name, a product or service description, a supplier name, a Stock Keeping Unit (SKU) description, and/or the like.

The user devices 104 may execute one or more applications that enable the respective users to provide the input sales orders to the system 102. Non-limiting examples of the one or more applications may include web applications, email applications, e-commerce applications, voice call applications, social media applications, messaging applications, chatbot applications, and/or the like. Therefore, the input sales orders may be provided by the user devices 104 to the system 102 through multiple channels (also be referenced as order sources). Further, the input sales orders may be associated with multiple formats such as, but are not limited to, structured formats, unstructured formats, semi-structured formats, and/or the like. For example, the input sales orders associated with the structured formats may include the input sales orders received through Electronic Data Interchange (EDI) (e.g., purchase orders, shipping forms, web forms, and/or the like). The input sales orders associated with the unstructured formats may include the input sales order received in text files of various types (e.g., word files, Portable Document Format (PDF) files, handwritten notes), image files of various types (e.g., a Joint Photographic Experts Group (JPEG) format, a Portable Network Graphic (PNG) format, a Graphic Interchange Format (GIF) format, and/or the like), voice calls, video files, emails, presentations, social media posts, fax, and/or the like. The input sales orders associated with the unstructured formats may include the input sales order received through Hyper Text Markup Language (HTML) forms, Extensible Markup Language (XML) data, and/or a combination thereof.

The system 102 may process the input sales orders received from the user devices 104. In some examples, the system 102 may be implemented as an on-premises system that is operated by an enterprise or a third-party engaged in cross-platform interactions and sales orders management. In some other examples, the system 102 may be implemented as an off-premises system (for example, cloud or on-demand) that is operated by an enterprise or a third-party on behalf of an enterprise. In some other examples, the system 102 may be implemented in a cloud environment. For simplicity, the system 102 depicted in FIG. 1 may be a cloud-based system that is intended to represent various forms of servers including a web server, an application server, a proxy server, a network server, a server pool, and/or the like.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications.

Still referring to FIG. 1, the system 102 includes a processor 114 and a memory 116 communicably coupled to the processor 114. The processor 114 may include one or more processors. Examples of the processor 114 may include, but are not limited to, microprocessors, microcomputers, microcontrollers, digital signal processors, central processing units, state machines, logic circuits, and/or any devices that manipulate data or signals based on operational instructions. Among other capabilities, the processor 114 may fetch instructions (also be referenced to as processor-executable instructions or machine-executable instructions) from the memory 116 and execute the fetched instructions for performing operations according to the present disclosure. The memory 116 may be non-volatile or non-transitory computer-readable medium (CRM) such as a magnetic disk or solid-state non-volatile memory or volatile medium such as Random Access Memory (RAM), and/or the like. Further, the system 102 includes a sales order manager 118 (also be referenced as Large Language Model (LLM) and graph enabled accent and trajectory identification (LGATI) framework). The sales order manager 118 may be stored in the memory 116 and provided as a downloadable library including the instructions. The sales order manager 118 includes User Interface (UI)/User Experience (UX) (UI/UX) module 120, a training engine 122, and an extraction engine 124. Various data and intermediate results generated by the UI/UX module 120, the training engine 122, and the extraction engine 124 may be stored in the internal database 110.

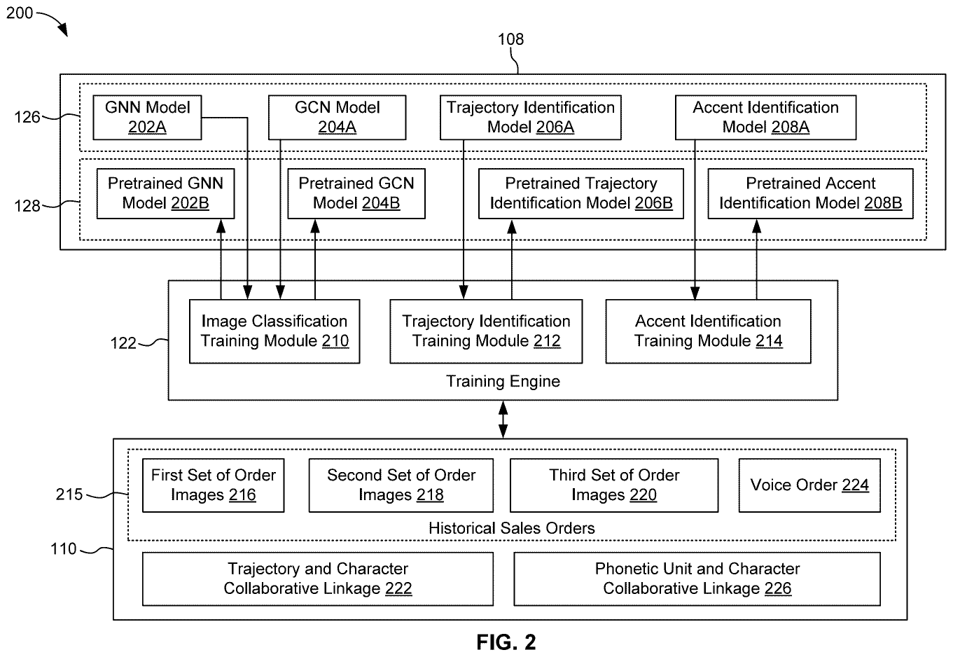

In an example implementation, the processor 114 may execute the training engine 122 to access Generative Artificial Intelligence (Gen AI) models 126 from the model database 108 and generate pretrained Gen AI models 128 for processing of the input sales orders. The Gen AI models 126, the pretrained Gen AI models 128, and the training engine 122 are described in detail in conjunction with FIG. 2.

In an example implementation, the processor 114 may execute the UI/UX module 120 to receive the input sales orders. In some examples, the input sales orders may be received from the user devices 104. In some other examples, the input sales orders may be received from various applications being executed on the system 102.

In some examples, the input sales orders may include voice orders (e.g., input sales orders received from the voice call applications). The voice orders may include spoken words. In some other examples, the input sales orders may include written orders (e.g., input sales orders received from the applications such as the messaging applications, the social media applications, the email applications, and/or the like). The written orders may include handwritten words, printed words, text, input sequence of words, and/or the like. The written orders may be stored in the internal database 110 in the form of images.

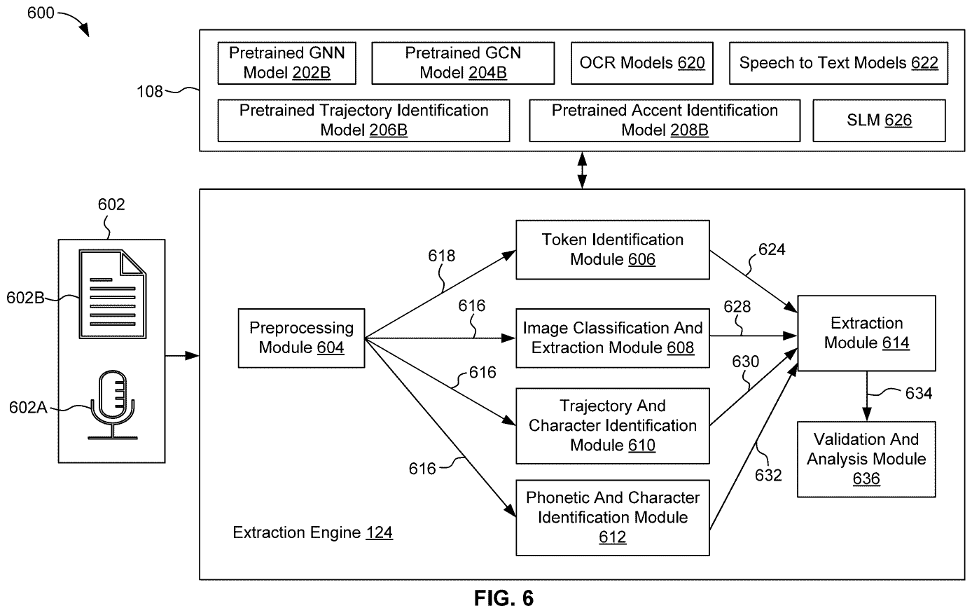

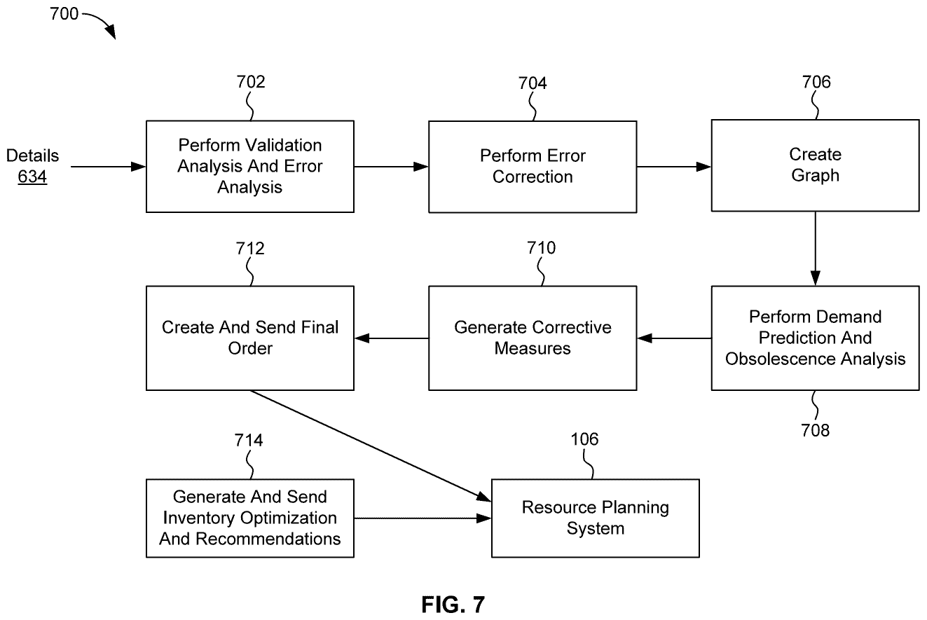

In an example implementation, the processor 114 may execute the extraction engine 124 to process the received input sales order using the pretrained Gen AI models 128. Processing the input sales orders may include extracting and validating details from the input sales order. The extraction engine 124 for processing the input sales orders is described in detail in conjunction with FIGS. 6 and 7.

In another example implementation, the processor 114 may execute the extraction engine 124 to create final orders corresponding to the input sales orders, when the extracted details of the input sales orders are validated successfully. The created final orders may be provided to the resource planning system 106 for facilitating a final delivery of products and/or services to the users.

Various examples depicting training of the Gen AI models 126 and processing the input sales orders using the pretrained Gen AI models 128 are described in detail in conjunction with FIGS. 2-9.

FIG. 2 depicts an example conceptual architecture 200 of the training engine 122 of the system 102 disclosed in the example environment of FIG. 1, for generating the pretrained Gen AI models 128, in accordance with implementations of the present disclosure. The training engine 122 may generate the pretrained Gen AI models 128 by accessing and training the Gen AI models 126 from the model database 108. As depicted in FIG. 2, the Gen AI models 126 may include a Graph Neural Network (GNN) 202A, a Graph Convolutional Network (GCN) 204A, a trajectory identification model 206A, and an accent identification model 208A. The trajectory identification model 206A may include a combination of a Large Language Model (LLM) and a GNN model. While implementations of the present disclosure are described in further detail herein with non-limiting reference to the combination of the LLM and the GNN as the example trajectory identification model 206A, it is contemplated that the trajectory identification model 206A may include a combination of any appropriate models such as foundation models or Machine Learning (ML) models, or Artificial Intelligence (AI) models. The accent identification model 208A may include a combination of an Automatic Speech Recognition (ASR)-based LLM and a GNN. While implementations of the present disclosure are described in further detail herein with non-limiting reference to the combination of the A SR-based LLM and the GNN as the example accent identification model 208A, it is contemplated that the accent identification model 208A may include a combination of any appropriate models such as foundation models or ML models, or Artificial Intelligence (AI) models. The pretrained Gen AI models 128 may include a pretrained GNN model 202B, a pretrained GCN model 204B, a pretrained trajectory identification model 206B (includes a combination of a pretrained LLM and a pretrained GNN), and a pretrained accent identification model 208B (includes a combination of a pretrained ASR-based LLM and a pretrained GNN).

The training engine 122, depicted in FIG. 2, includes an image classification training module 210, a trajectory identification training module 212, and an accent identification training module 214 for generating the pretrained Gen AI models 128.

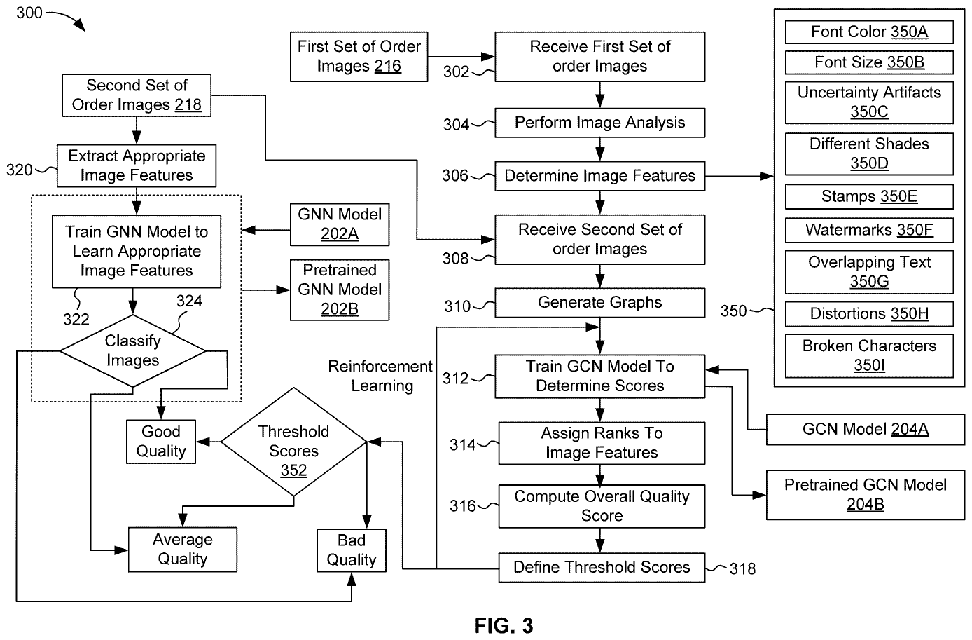

The image classification training module 210 may generate the pretrained GNN model 202B and the pretrained GCN model 204B, which may be used in processing the input sales order including the written orders. The image classification training module 210 may generate the pretrained GNN model 202B and the pretrained GCN model 204B by training the GNN model 202A and the GCN model 204A, respectively, using a first set of order images 216 and a second set of order images 218 stored in the internal database 110. The first set of order images 216 and the second set of order images 218 may correspond to images of historical sales orders 215 (also be referenced as historical order data, historical data, historical records, and/or the like) collected over time. An example training process flow 300 of training the GNN model 202A and the GCN model 204A to generate the pretrained GNN model 202B and the GCN model 204B, respectively is depicted in detail along with FIG. 3.

As depicted in FIG. 3, the image classification training module 210 may receive 302 the first set of order images 216 from the internal database 110 (depicted in FIGS. 1 and 2). The first set of order images 216 may include the images of the historical sales orders 215 and may be associated with any image quality standards such as, but are not limited to, a good quality, an average quality, and a bad quality.

Upon receiving the first set of order images 216, the image classification training module 210 may perform 304 image analysis on the first set of order images 216 and determine 306, based on the performed image analysis, image features 350 that may impact a quality of an image. In an example, the image features 350 may include properties or characteristics of the image such as, but are not limited to, font color 350A, a font size 350B, uncertainty artifacts 350C (e.g., blur, high or low contrast, high or low brightness, and/or the like), different shades 350D, stamps 350E, watermarks 350F, overlapping text 350G, distortions 350H, broken characters 350I, and/or the like.

After determining the image features 350, the image classification training module 210 may receive 308 the second set of order images 218 from the internal database 110. The second set of order images 218 may include the images (of the historical sales orders 215) classified with the image quality standards such as, the good quality, the average quality, and the bad quality, based on quality of each of the images.

The image classification training module 210 may generate 310 graphs corresponding to the second set of order images 218. A graph corresponding to an order image in the second set of order images 218 may include nodes and edges between the nodes. The nodes may represent pixels of the respective order image and edge weightage associated with the edges may represent pixel values or pixel coordinates associated with the respective pixels (e.g., the respective nodes).

Upon generating the graphs, the image classification training module 210 may train 312 the GCN model 204A to determine scores for the second set of order images 218. The scores for the second set of order images 218 may be determined by determining scores for relationships between the nodes in each of the graphs using the GCN model 204A. Upon generating the scores for the second set of order images 218 using the GCN model 204A, the image classification training module 210 may standardize or normalize the scores into a unique score format.

Further, the image classification training module 210 may assign 314 ranks to the image features 350, based on the scores generated for the relationships between the nodes in each of the graphs. In some examples, the image classification training module 210 may train the GCN model 204A to assign the ranks to the image features 350 by identifying the scores generated for the relationships between the nodes in each of the graph and standardizing or normalizing the scores into a single scale.

Once the ranks are assigned to the image features, the image classification training module 210 may compute 316 an overall quality score (QS). By way of non-limiting example, the image classification training module 210 may use a weighted technique for computing the overall QS. In accordance with the weighted technique, the image classification training module 210 may compute 316 the overall QS by assigning different weights for the image features 350 based on the respective ranks. The different weights may identify relative importance of the image features 350.

Once the overall QS is computed, the image classification training module 210 may define 318 threshold scores 352 (also be referenced as threshold values) for each of the image quality standards associated with the images in the second set of order images 218. By way of non-limiting examples, the threshold scores 352 may include 7.4 and above, 4.6 to 7.4, and 4.6 and below for the image quality standards such as the good quality, the average quality, and the bad quality. If the overall QS of an image is 7.4 or greater than 7.4, the respective image may be associated with the good quality. If the overall QS of the image is greater than 4.6 and lesser than 7.4, the respective image may be associated with the average quality. If the overall QS of the image is 4.6 or less than 4.6, the respective image may be associated with the bad quality. Based on the defined threshold scores, the image classification training module 210 may iteratively train the GCN model 204A using a Reinforcement Learning (RL) technique. During each iteration, in accordance with the RL technique, the image classification training module 210 may compute a reward function based on the threshold scores defined in a previous iteration, train the GCN model 204A to generate the scores for the second set of order images 218 based on the computed reward function, generate the ranks for the attributes, compute the overall QS for the images in the second set of order images 218 associated with each of the image quality standards based on the ranks, and define the threshold scores. Iteratively training the GCN model 204A may generate the pretrained GCN model 204B.

In parallel, after receiving the second set of order images 218 from the internal database 110, the image classification training module 210 may extract 320 appropriate image features from each image in the second set of order images 218. In some examples, the appropriate image features may include any of the image features 350 such as the font color 350A, the font size 350B, the uncertainty artifacts 350C (e.g., blur, high or low contrast, high or low brightness, and/or the like), the different shades 350D, the stamps 350E, the watermarks 350F, the overlapping text 350G, the distortions 350H, the broken characters 350I, and/or the like.

Once the appropriate image features are extracted, the image classification training module 210 may train 322 the GNN model 202A to learn the appropriate image features corresponding to the images in the second set of order images 218. Based on the learned appropriate image features and threshold scores 352 defined using the GCN model 204A, the image classification training module 210 may train 322 the GNN model 202A to classify 324 each image in the second set of images into the image quality standards such as the good quality, the average quality, and the bad quality. Such training of the GNN model 202A may generate the pretrained GNN model 202B.

The pretrained GNN model 202B and the pretrained GCN model 204B may be used to classify images of the input sales orders, which is described in detail in conjunction with FIG. 6. The pretrained GNN model 202B and the pretrained GCN model 204B may be stored in the model database 108.

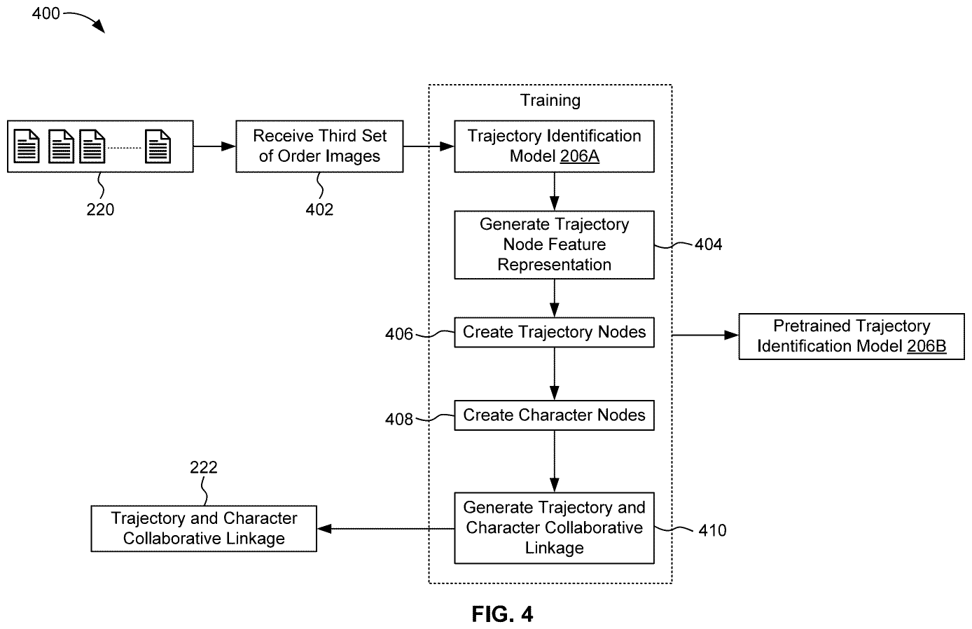

Referring back to FIG. 2, the trajectory identification training module 212 may generate the pretrained trajectory identification model 206B by training the trajectory identification model 206A. The trajectory identification training module 212 may train the trajectory identification model 206A using a third set of order images 220 of the historical sales orders 215. The third set of order images 220 may include images of the historical sales orders 215 without any classification (e.g., without associating with any image quality standards such as the good quality, the average quality, and the bad quality). It should be noted that the third set of order images 220 may include the first set of order images 216. Training of the trajectory identification model 206A may result in the pretrained trajectory identification model 206B while creating a trajectory and character collaborative linkage 222 (also be referenced as trajectory and character wiki). An example training process flow 400 of training the trajectory identification model 206B to generate the pretrained trajectory identification model 206B is described in detail in conjunction with FIG. 4.

As depicted in FIG. 4, the trajectory identification training module 212 may receive 402 the third set of order images 220 from the internal database 110 (depicted in FIGS. 1 and 2). The third set of order images 220 may include the images of the historical sales orders 215. The images in the third set of order images 220 may include text, words, input sequence, and/or the like, including characters. In some examples, the characters may be handwritten. In some other examples, the characters may be in the form of a calligraphy style, drawings, and/or the like.

Upon receiving the third set of order images 220, the trajectory identification training module 212 may provide the third set of order images 220 to the trajectory identification model 206A and train the trajectory identification model 206A to generate 404 a trajectory node feature representation, create 406 trajectory nodes, create 408 character nodes or central nodes, and generate 410 trajectory and character collaborative linkage 222 (also be referenced as trajectory and character wiki).

The trajectory node feature representation may be generated by identifying multiple series of pixels as trajectories (also be referenced as strokes) and representing the trajectories as nodes. The trajectory node feature representation may correspond to a graphical entity including the nodes corresponding to the trajectories. The trajectories may include pixels that contribute to form each of the characters in the images of the third set of order images 220. Therefore, the nodes may represent properties of the respective trajectories that contribute together to form each respective character. A node corresponding to a trajectory may include features such as start and end coordinates (also be referenced as pixel coordinates), a length of the respective trajectory, an angle of the respective trajectory, and supplementary features. Non-limiting examples of the supplementary features may include trajectory thickness, curvature, and direction. In some examples: (i) the start and end coordinates may be represented as (x₁, y₁, x₂, y₂); (ii) the length of the trajectory may be computed as: length=\sqrt{(x₂−x₁)²+(y₂−y₁)²}; and (iii) the angle of the trajectory with an x-axis may be computed as:

$$θ arctan ( \frac{{y}_{2} - {y}_{1}}{{x}_{2} - {x}_{1}} ) .$$

By way of non-limiting example, a straight trajectory (e.g., a path follows a straight line and represented by two pixels) from a point (1, 1) to another point (4, 5) may be represented as a node with:
start coordinates: (1, 1)
end coordinates: (4, 5)
length=\sqrt{(4−1)²+(5−1)²=5}

$$angle = θ = arctan ( \frac{5 - 1}{4 - 1} ) = 53.13$$

The trajectory nodes may be created for each of the characters in the images of the third set of order images 220 based on the generated trajectory node feature representation. In an implementation, creating the trajectory nodes may include identifying the characters from the images of the third set of order images 220, determining the trajectories associated with each of the identified characters, and assigning the nodes corresponding to the determined trajectories in the trajectory node feature representation as the trajectory nodes for each of the character. By way of non-limiting example, for a character “A,” the trajectory identification training module 212 may determine the trajectories such as a left diagonal line, a right diagonal line, and a crossbar. In such an example, the trajectory identification training module 212 may assign nodes corresponding to the determined trajectories as trajectory nodes ‘N₁,’ ‘N₂,’ and ‘N₃’ for the character “A.”

The character nodes or central nodes may be created by identifying the characters in the images of the third set of order images 220. Therefore, the character nodes or central nodes may represent the characters. Further, each of the character nodes or central nodes may be connected to the respective one or more trajectory nodes. By way of non-limiting example, consider that for a character “A,” a central node “C_{A}” may be created. In such an example, the central node “C_{A}” may be connected to the trajectory nodes (‘N₁,’ ‘N₂,’ and ‘N₃’) assigned for the character “A.”

The trajectory and character collaborative linkage 222 may be generated by creating a link between the trajectory nodes and each of the respectively connected character nodes or central nodes. For creating the link, edges may be formed between the trajectory nodes and each of the respective connected character nodes central nodes by capturing a structural relationship between the trajectory nodes and each of the respectively connected character nodes or central nodes. The edges may have edge weights, which may encode spatial proximity or dependency. For example, if the character node or central node corresponding to the character ‘A’ is connected to the trajectory nodes (‘N₁,’ ‘N₂,’ and ‘N₃’), the link or edge may be created between each of the trajectory nodes (‘N₁,’ ‘N₂,’ and ‘N₃’) to the character node or central node. Edge weights associated with the created link or edge may encode spatial proximity or dependency, for example, a trajectory's sequence or geometric alignment.

The above-described training process flow 400 of training the trajectory identification model 206A may result in generation of the pretrained trajectory identification model 206B, while generating the trajectory and character collaborative linkage 222. The pretrained trajectory identification model 206B may be trained for written character identification that involves identifying the characters from the input sales orders including the written orders (e.g., handwritten orders), which is described in detail in FIG. 6. The pretrained trajectory identification model 206B and the trajectory and character collaborative linkage 222 may be stored in the model database 108 and the internal database 110, respectively.

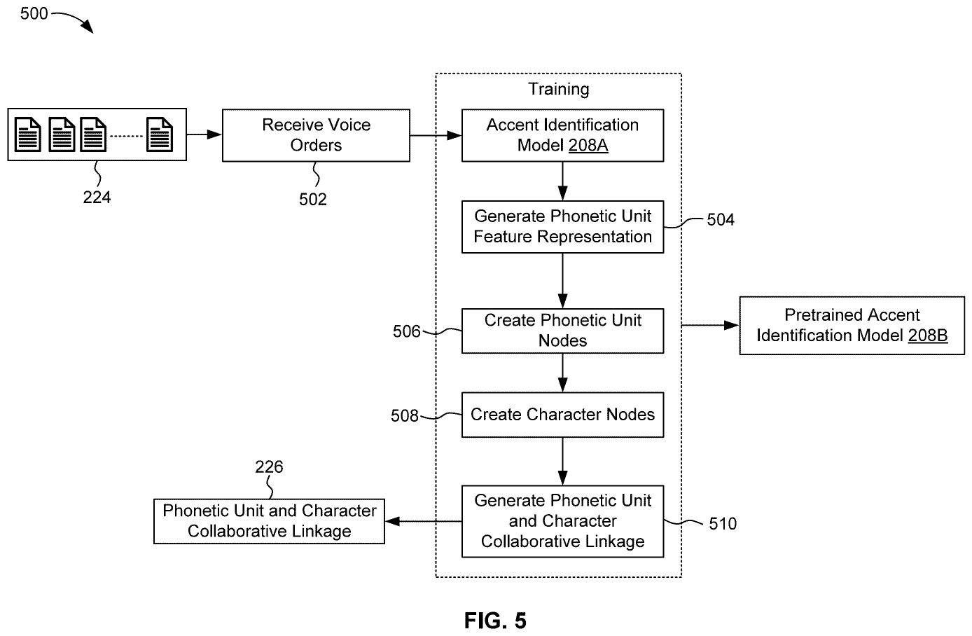

Referring back to FIG. 2, the accent identification training module 214 may generate the pretrained accent identification model 208B by training the accent identification model 208A. The pretrained accent identification model 208B may be used for processing the input sales orders including the voice orders. The accent identification training module 214 may train the accent identification model 208A using voice orders 224 of the historical sales orders 215. The voice orders 224 may include spoken words extracted from text of the historical sales orders 215. For training the accent identification training module 214, the voice orders 224 in the form of text may be considered. Training of the accent identification model 208A may result in the pretrained accent identification model 208B while creating a phonetic unit and character collaborative linkage 226 (also be referenced as phonetic unit and character wiki). An example training process flow 500 of training the accent identification model 208A to generate the pretrained accent identification model 208B is described in detail in conjunction with FIG. 5.

As depicted in FIG. 5, the accent identification training module 214 may receive 502 the voice orders 224 (e.g., in the form of text). The accent identification training module 214 may provide the voice orders 224 to the accent identification model 208A and train the accent identification model 208A to generate 504 a phonetic unit feature representation, create 506 phonetic unit nodes, create 508 character nodes or central nodes, and generate 510 the phonetic unit and character collaborative linkage 226.

The phonetic unit feature representation may be generated by identifying phonetic units (also be referenced as phoneme, syllable, diphone, and/or the like) in the voice orders 224 and representing the phonetic units as nodes. Therefore, the phonetic unit representation may correspond to a graphical entity including the nodes corresponding to the phonetic units. The phonetic units may refer to sound that may differentiate meaning between words in a language. Each node may have acoustic and linguistic features. Non-limiting examples of the acoustic and linguistic features may include spectral features, temporal features, phoneme categories, articulatory features, and/or the like. The spectral features may include formants (e.g., F1, F2, F3), Mel-Frequency Cepstral Coefficients (MFCCs), and/or the like. The temporal features may include duration, pitch, sound intensity, and/or the like. The phoneme categories may include vowels, consonants, diphthong, nasal, and/or the like. The articulatory features may include place and manner of articulation, voicing, and/or the like. By way of non-limiting example, a node corresponding to a phonetic unit may have the features such as: F1=300 Hertz (Hz), F2=1500 Hz, F3=2500 Hz, duration=60 milliseconds (ms), Voiceless, Bilabial, and Plosive.

The phonetic unit nodes may be created for each of the spoken words in the voice orders 224 based on the phonetic unit feature representation. In an implementation, creating the phonetic unit nodes may include identifying the spoken words from the voice orders 224, determining the phonetic units associated with each of the identified spoken words, and assigning the nodes corresponding to the determined phonetic units in the phonetic unit feature representation as the phonetic nodes for each of the spoken words. The phonetic unit nodes may capture the acoustic and linguistic features of the spoken words. By way of non-limiting examples, for a spoken word like “CAT” (/kaet/), the phonetic units such as ‘/k/,’ ‘/ae/,’ and ‘/t/’ may be determined and the respective nodes are determined as phonetic unit nodes (e.g., ‘N₁,’ ‘N₂,’ and ‘N₃’) for the spoken word “CAT.”

The character nodes or central nodes may be created by identifying the spoken words in the voice orders 224. The character nodes or central nodes may represent the characters in the text corresponding to the spoken words of the voice orders 224. Further, each of the character nodes or central nodes may be connected to respective one or more phonetic unit nodes, thereby generating a phonetic unit to character mapping. By way of non-limiting example, a character node or central node “C_CAT” may be created for a character “C” in the spoken word “CAT” and connected to the respective phonetic unit node (e.g., ‘N₁’).

The phonetic unit and character collaborative linkage 226 may be created by creating a link between the phonetic unit nodes and each of the respectively connected character nodes or central nodes. For creating the link, edges may be formed between phonetic unit nodes and each of the respective connected character nodes central nodes. The edges may have edge weights, which may encode relationships such as phonetic proximity, stress patterns, co-articulation effects, and/or the like. By way of non-limiting example, a character “A” in the spoken word “CAT” may be linked to a respective phonetic unit “/ae/” with an edge weight representing its vowel stress level.

The above-described training process flow 500 of training the accent identification model 208A may result in generation of the pretrained accent identification model 208B, while generating the phonetic unit and character collaborative linkage 226. The pretrained accent identification model 208B may be trained for phonetic character identification that involves identifying the characters from the input sales orders including the voice orders, which is described in detail in FIG. 6. The pretrained accent identification model 208B and the phonetic unit and character collaborative linkage 226 may be stored in the model database 108 and the internal database 110, respectively.

FIG. 6 depicts an example conceptual architecture 600 of the extraction engine 124 of the system 102 disclosed in the example environment 100 of FIG. 1, for processing an input sales order 602, in accordance with implementations of the present disclosure. The extraction engine 124, depicted in FIG. 6, includes a preprocessing module 604, a token identification module 606, an image classification and extraction module 608, a trajectory and character identification module 610, a phonetic and character identification module 612, an extraction module 614, and a validation and analysis module 636.

The preprocessing module 604 may receive the input sales order 602 and preprocess the input sales order 602, thereby generating a preprocessed input sales order 616. The input sales order 602 may be received from one of the user devices 104 (depicted in FIG. 1) through the multiple channels such as, but are not limited to, voice calls, emails, text files (e.g., PDFs, written notes, fax, and/or the like), EDI, text messages, social media messages, web portals, e-commerce portals, and/or the like. The input sales order 602 may be associated with the different formats such as a structured format, an unstructured format, a semi-structured format, or a combination thereof. The input sales order 602 received through the voice calls may include a voice order 602A.

The input sales order 602 received through one or more of: the emails, the text files, the EDI, the text messages, the social media messages, the web portals, the e-commerce portals, and/or the like, may include a written order 602B. The written order 602B may be in the form of an image including written or handwritten text, printed text, drawings, and/or the like. As would be understood, the input sales order 602 may include the voice order 602A, the written order 602B, or a combination thereof.

If the input sales order 602 includes the voice order 602A, the preprocessing module 604 may generate the preprocessed input sales order 616 by performing noise cancellation on the voice order 602A. If the input sales order 602 includes the written order 602B, the preprocessing module 604 may generate the preprocessed input sales order 616 by performing image processing on the image of the written order 602B. In some examples, the image processing may include gray scaling, rescaling, denoising, normalization, and/or the like. After preprocessing the input sales order 602, the preprocessing module 604 may provide an image of the preprocessed input sales order 616 (corresponding to the input sales order 602 including the written order 602B) to the image classification and extraction module 608, and the trajectory and character identification module 610. In addition, after preprocessing the input sales order 602, the preprocessing module 604 may provide the preprocessed input sales order 616 (corresponding to the input sales order 602 including the voice order 602A) to the phonetic and character identification module 612. As would be understood, the image classification and extraction module 608, and the trajectory and character identification module 610 may be operated when the input sales order 602 includes the written order 602B and the phonetic and character identification module 612 may be operated when the input sales order 602 includes the voice order 602A.

Additionally, or alternatively, the preprocessing module 604 may extract text 618 from the preprocessed input sales order 616 and normalize a format of the text 618. In an example, the preprocessing module 604 may use Optical Character Recognition (OCR) models 620 stored in the model database 108 for extracting the text from the preprocessed input sales order 616 including the written order 602B. In another example, the preprocessing module 604 may use speech to text models 622 stored in the model database 108 for extracting the text from the preprocessed input sales order 616 including the voice order 602A. The extracted text 618 may be provided to the token identification module 606.

The token identification module 606 may identify tokens 624 from the text 618 received from the preprocessing module 604. The tokens may represent spoken words in the voice order 602A. The tokens may represent text, words, an input sequence, and/or the like, in the written order 602B. In an example, the token identification module 606 may use a Small Language Model (SLM) 626 stored in the model database 108 for identifying the tokens from the text 618. The SLM 626 may be one of the pretrained Gen AI models 128 or a generic model. The identified tokens 624 may be provided to the extraction module 614 and/or stored in the internal database 110 (depicted in FIG. 1).

The image classification and extraction module 608 may receive the preprocessed input sales order 616 in the form of the image. The image classification and extraction module 608 may provide the image of the preprocessed input sales order 616 to the pretrained GNN model 202B and the pretrained GCN model 204B. The pretrained GCN model 204B may be used to define threshold scores for the image quality standards such as a good quality, an average quality, and a bad quality, based on analysis of image features of the image that may affect a quality of the image of the preprocessed input sales order 616. The pretrained GNN model 202B may be used to extract the image features from the image of the preprocessed input sales order 616, generate scores for the image features, generate an overall QS for the image features based on the generated score, and classify the image of the preprocessed input sales order 616 into one of the image quality standards based on the generated overall QS and the threshold scores defined using the pretrained GCN model 204B. Non-limiting examples of the image features may include a font color, a font size, a form color, a shading of the color, a stamp, a watermark, an overlapping text, a broken character, and/or a distortion. Once the image of the preprocessed input sales order 616 is classified, the image classification and extraction module 608 may identify the image quality standard associated with the image of the preprocessed input sales order 616. If the image quality standard associated with the image of the preprocessed input sales order 616 satisfies a specific or predefined image quality standard, the image classification and extraction module 608 may use the pretrained GNN model 202B to extract text 628 from the respective image of the preprocessed input sales order 616. By way of non-limiting example, the specific or predefined image quality standard may include the image quality standard like the bad quality, or the good quality, or the average quality. The extracted text 628 corresponding to the respective image of the preprocessed input sales order 616 may be provided to the extraction module 614 and/or stored in the internal database 110.

The trajectory and character identification module 610 may be operated if the input sales order 602 includes the written order 602B in the form of the image. The trajectory and character identification module 610 may determine characters 630 from the image of the preprocessed input sales order 616 (corresponding to the input sales order 602) by performing the written character identification using the pretrained trajectory identification model 206B. To illustrate, the trajectory and character identification module 610 may provide the image of the preprocessed input sales order 616 to the pretrained trajectory identification model 206B, which may be used to perform the written character identification for identifying the characters 630 from the image of the preprocessed input sales order 616. The written character identification may involve trajectory feature vector generation and trajectory identification and node classification.

The trajectory feature vector generation may include identifying trajectory nodes from the image of the preprocessed input sales order 616 and creating feature vectors for each of the trajectory nodes. The trajectory nodes may correspond to trajectories associated with each of the characters in the image of the input sales order 602. The feature vectors corresponding to a trajectory node may represent embeddings or vector representations of the features represented by the trajectory node. The feature vectors may be created for each of the trajectory nodes using geometric and contextual properties associated with the respective characters in the image of the preprocessed input sales order 616. The feature vectors of the trajectory node may indicate one or more of: start and end points, a length of the trajectory and an angle of the trajectory, By way of non-limiting example, a trajectory node with a start point (1, 1) and an end point (4, 5) has a feature vector: [1, 1 (start point), 4, 5 (end point), 5 (length), 53.13° (angle)]. Additionally, or alternatively, the feature vectors may represent additional or supplementary features such as curvature, pressure, trajectory dynamics, and/or the like.

The trajectory identification and node classification may include classifying the identified trajectory nodes into a predefined category based on the respective feature vectors. By way of non-limiting example, the predefined category may include a horizontal line, a diagonal line, curve, and/or the like. In an example, a trajectory node “N₁” with a feature vector [1, 1, 4, 5, 5, 53.13°] may be classified as a diagonal trajectory. In another example, a trajectory node “N₂” with a feature vector [0, 5, 5, 5, 5, 0°] may be classified as a horizontal trajectory.

Once the trajectory nodes are classified, the trajectory identification and node classification may access the trajectory and character collaborative linkage 222 from the internal database 110 and determine the characters 630 for the trajectory nodes that have been classified into the predefined category. Therefore, the characters 630 may be determined from the image of the preprocessed input sales order 616. The determined characters may be provided to the extraction module 614 and/or stored in the internal database 110.

The phonetic and character identification module 612 may be operated if the input sales order 602 includes the voice order 602A with the spoken words. The phonetic and character identification module 612 may determine characters 632 from the spoken words in the preprocessed input sales order 616 (corresponding to the input sales order 602) by performing the phonetic character identification using the pretrained trajectory identification model 206B. It should be noted that the spoken words may be extracted from the text (e.g., the text 618) derived after preprocessing the voice order (e.g., the preprocessed input sales order 616). To illustrate, the trajectory and character identification module 610 may provide the spoken words in the preprocessed input sales order 616 to the pretrained accent identification model 208B, which may be used to perform the phonetic character identification for identifying the characters 632 from the spoken words in the preprocessed input sales order 616. The phonetic character identification may involve phonetic node classification and character identification and link prediction.

The phonetic node classification may include identifying phonetic unit nodes for the spoken words in the preprocessed input sales order 616, determining feature vectors associated with the identified phonetic unit nodes, and classifying the identified phonetic unit nodes into predefined phonetic unit categories based on the respective feature vectors. The feature vectors may represent embeddings or vector representations of the features (e.g., spectral features, temporal features, phoneme categories, articulatory features, and/or the like) associated with the phonetic unit nodes. The predefined phonetic unit categories may include speech sounds. Classifying the phonetic unit nodes into the predefined phonetic unit categories may ensure that the feature vectors of the phonetic unit nodes appropriately represent speech sounds. In an example, a phonetic unit node “N₁” with a feature vector [F1 (spectral feature): 300 Hz, F2 (temporal feature): 1500 Hz, Voiceless, Plosive (phoneme category and articulatory feature)] may be classified as “/p/.” In another example, a phonetic unit node “N₂” with a feature vector [F1: 700 Hz, F2: 1200 Hz, Nasal] may be classified as a “/m/.”

The character identification and link prediction may include accessing the phonetic unit and character collaborative linkage 226 from the internal database 110 and use the phonetic unit and character collaborative linkage 226 to determine the characters 632 from the spoken words of the preprocessed input sales order 616 by establishing missing or uncertain relationships between the spoken words and the phonetic unit nodes. Establishing the missing or uncertain relationships between the spoken words and the phonetic unit nodes may aid in determining the characters 632 in scenarios where accents or handwriting variations cause ambiguity in mapping. By way of non-limiting example, a spoken word “CAT” may be predicted for a phonetic unit node with an uncertain phoneme sequence “/kaet/”, based on contextual and acoustic similarity. The characters 632 identified from the spoken words of the input sales order 602 may be provided to the extraction module 614.

The extraction module 614 may receive the tokens 624 from the token identification module 606, and one or more of: the text 628 from the image classification and extraction module 608, and the characters 630 from the trajectory and character identification module 610, and the characters 632 from the phonetic and character identification module 612 and accordingly extract details 634 (also e.g., attributes, fields, and/or the like) corresponding to the input sales order 602.

For extracting the details 634, the extraction module 614 may perform word formulation to formulate words from the tokens 624 and the characters 630 and 632. The characters 630 may include the characters identified from the image of the preprocessed input sales order 616 and/or the characters 632 identified from the spoken words of the preprocessed input sales order 616. Once the words are formulated, the extraction module 614 may perform word identification to identify final words for the input sales order. The extraction module 614 may further use the text 628 and/or the final words to extract the details 634. The details 634 may include an order number, a product or service name, a product or service identifier (ID), a product or service description, a supplier name, a quantity, a stock keeping unit (SKU) description, a price, and/or the like.

In some examples, the extraction module 614 may further predict missing details from the input sales order 602 using the historical sales orders, rule-based models, or M L models (not shown in FIG. 6) and integrate the predicted missing details with the details extracted from the input sales order. The extraction module 614 may provide the details 634 (along with the predicted missing details) of the input sales order 602 to the validation and analysis module 636.

The validation and analysis module 636 may perform various tasks, which are described in detail along with process flow in FIG. 7. As depicted in FIG. 7, once the details 634 (along with the predicted missing details) of the input sales order 602 are received, the validation and analysis module 636 may perform 702 validation analysis and error analysis. The validation analysis may include cross validating the details 634 extracted from the input sales order 602 with master details or cross-reference details stored in the internal database 110 (depicted in FIG. 1). The error analysis may include detecting anomalies or errors in the details 634 extracted from the input sales order 602. The detected anomalies or errors may indicate price mismatches, invalid SKU descriptions, quantity mismatches, incorrect product or service descriptions, and/or the like.

Upon detecting the anomalies or errors from performing the error analysis, the validation and analysis module 636 may perform 704 error correction. The error correction may involve flagging the input sales order 602 detected with the anomalies or errors and routing the input sales order 602 to a manual correction. An operator of the system 102 may rectify or correct the anomalies or errors in the details 634 extracted from the input sales order 602 using the master details or cross-reference details.

After performing the error correction, the validation and analysis module 636 may create 706 a graph by re-performing the validation to ensure data integrity. The graph may include nodes representing some or all of the details (e.g., SKUs, suppliers, and/or the like) extracted from the input sales order 602 and associated user relationships.

The validation and analysis module 636 may further perform 708 demand prediction and obsolescence analysis. The demand prediction and obsolescence analysis may include predicting demand and obsolescence for one or more of: a short-term planning, a mid-term planning, and/or a long-term planning and generating recommendations for optimal inventory levels. The recommendation for the optimal inventory levels may include suggestions for maintaining a quantity of products in stock at any time while satisfying demands of the users or customers. In some examples, the validation and analysis module 636 may perform the demand prediction and obsolescence analysis using M L models (not shown in FIG. 7).

Additionally, or alternatively, the validation and analysis module 636 may generate 710 corrective measures to mitigate the anomalies or errors detected with the input sales order 602 in future. The validation and analysis module 636 may trace the anomalies or errors detected with the input sales order 602 to specific steps in extracting the details from the input sales order 602 (e.g., inappropriate capturing or misreading of the input sales order 602, incorrect image classification, incorrect words formulation, and/or the like) for generating the corrective measures.

The validation and analysis module 636 may create and send 712 a final order corresponding to the input sales order 602 that has been validated and rectified (in case of the anomalies or errors) to the resource planning system 106 (e.g., an ERP system, a CRM system, and/or the like). The final order may include an order ID or number generated for facilitating the input sales order 602. The final order may be notified to one or more of suppliers, logistics teams, and/or the like.

A long with sending the final order to the resource planning system 106, the validation and analysis module 636 may generate and send 714 inventory optimization and recommendations to the resource planning system 106. The inventory optimization and recommendations may include recommending optimal inventory levels for each SKU, notify or highlight critical inventory risks (e.g., overstock, shortages, and/or the like), and/or the like.

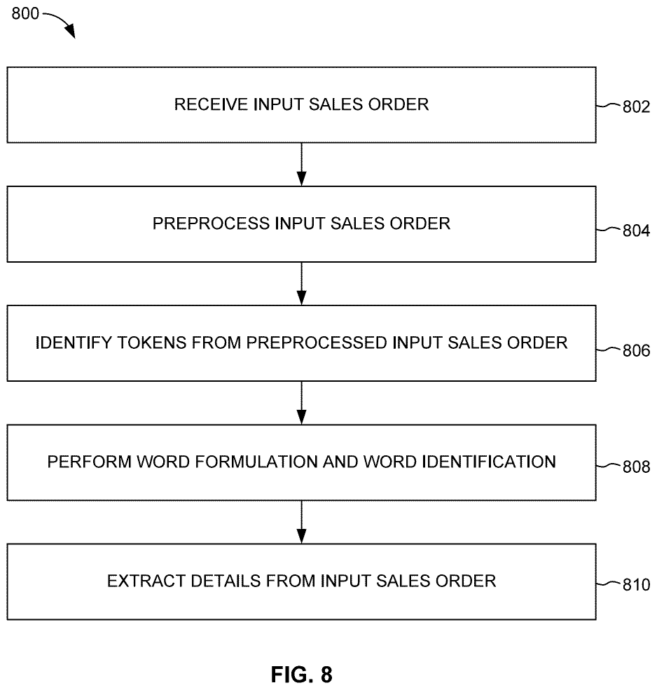

FIG. 8 is a flow diagram that presents an example computer implemented method 800 for processing the input sales order 602 (depicted in FIG. 6), in accordance with implementations of the present disclosure. In some implementations, the method 800 may be executed by the processor 114 (including the one or more processors) using the components 122-124 of the sales order manager, as described in relation to FIGS. 1-7.

The method 800 includes receiving 802 the input sales order 602. The input sales order 602 may be received from the multiple channels and associated with the different formats. The input sales order 602 may include the voice order 602A or the written order 602B, or a combination thereof.

The method 800 includes preprocessing 804 the input sales order 602 for processing using one or more of the pretrained Gen AI models 128 (depicted in FIGS. 1 and 2). In some examples, if the input sales order 602 is received as the voice order 602A, then preprocessing the input sales order 602 may include performing noise cancellation for the voice order 602A. In some other examples, if the input sales order 602 is received as the written order 602B, then preprocessing the input sales order 602 may include performing image processing on the image of the input sales order 602 by performing one or more of: gray scaling, rescaling, denoising, and/or normalization.

Once the input sales order 602 is preprocessed, the method 800 includes identifying 806 the tokens 624 (depicted in FIG. 6) from the preprocessed input sales order 616 using one or more of pretrained Gen AI models 128 (e.g., the SLM 626).

In some examples, after preprocessing the input sales order 602, the method 800 includes identifying the image features from the image of the input sales order 602, classifying the image into one of the image quality standards based upon the overall QS computed for the image features, and extracting the text 628 from the image that meets at least a specific image quality standard of the plurality of image quality standards. The overall QS may be computed using a weighted technique on the image features including a font color, a font size, a form color, a shading of the color of the image, a stamp, a watermark, an overlapping text, a broken character, and/or a distortion. Extracting the text 628 is described in detail along with the image classification and extraction module 608 in FIG. 6, therefore repeated description is omitted herein for sake of brevity.

The method 800 further includes performing 808 the word formulation and the word identification of the input sales order 602 by extracting characters 630 and 632 from the input sales order using one or more of the pretrained Gen AI models 128. The one or more pretrained Gen AI models are trained for the handwritten character identification and the phonetic character identification. Results of the word formulation and the word identification may provide words extracted from the input sales order 602. Performing the word formulation and the word identification using one or more of the pretrained Gen AI models 128 is described in detail along with the extraction module 614 in FIG. 6, therefore repeated description is omitted herein for sake of brevity.

The method 800 includes extracting 810 the details 634 from the input sales order 602 based on the tokens, and the results of the performed word identification and word formulation of the input sales order. Extraction of the details 634 from the input sales order 602 is described in detail along with the extraction module 614 in FIG. 6, therefore repeated description is omitted herein for sake of brevity.

In some examples, the method 800 may further include predicting missing data in the details 634 extracted from the input sales order 602 using the historical sales order or historical records, rule-based models, and/or ML techniques, and predicting demand and obsolescence for one or more of: a short-term planning, a mid-term planning, and/or a long-term planning, and generating recommendations for an inventory level, which are described in detail along with the validation and analysis module 636 in FIG. 7, therefore repeated description is omitted herein for sake of brevity.

Implementations of the present disclosure provide technical solutions to multiple technical problems that arise in the context of processing sales orders or input sales orders. Implementations of the present disclosure provide a LGATI framework for processing the sales orders with high accuracy and with reduced time, cost, and utilization of computing resources, which may allow timely fulfillment of the sales order. The LGATI framework may enable processing of the sales orders without any manual intervention and by supporting ingestion of the sales orders (including multi-lingual orders) from the multiple channels and in various formats. The LGATI framework may further provide actionable insights by unifying and analyzing the input sales orders received across all the multiple channels.

Further, the LGATI framework may enable processing of the sales orders using one or more of the pretrained Gen AI models and using structured knowledge representation. The pretrained Gen AI models may include a pretrained trajectory identification model, which may be trained to determine characters from images of the input sales orders by identifying properties of trajectories or strokes contributing to the respective characters and performing trajectory-based character structuring, which may result in accurate or precise determination of the characters. The pretrained Gen AI models may include a pretrained accent identification model, which may be trained to determine characters from spoken words in the input sales order by mapping phonetic unit nodes with the characters in the spoken words and using a graph theory to speech acoustics, thereby dynamically adapting phonetics for regional speech patterns (e.g., local accents) and industry-speech patterns and enabling real-time adaptation and refinement of text corresponding to the spoken words. Therefore, the LGATI framework may efficiently and effectively process the input sales orders by combining image-based handwritten text recognition (HWR) and speech-based voice recognition (VR) into a unified framework.

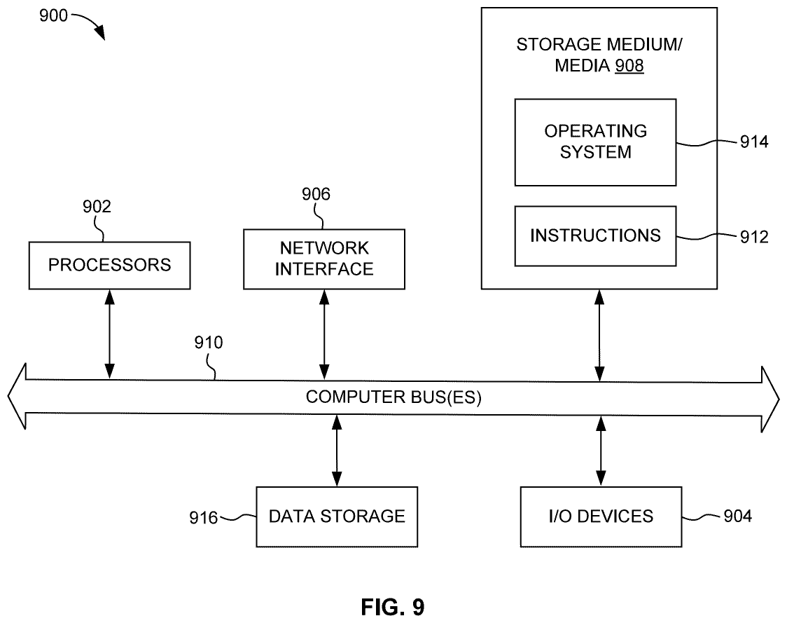

FIG. 9 depicts a computer system 900 that may be used to implement the system 102.

More particularly, computing machines such as desktops, laptops, smartphones, tablets, and wearables which may be used to process the input sales order. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902 such as, a central processing unit, ASIC or another type of processing circuit, input/output devices 904 such as, a display, mouse keyboard, etc., a network interface 906 such as, a Local Area Network (LAN), a wireless 802.11x LAN, a 3G or 4G mobile WAN or a WiMax WAN, and a storage medium or media 908 (also be referenced to as computer-readable medium (CRM)). Each of these components may be operatively coupled to a bus 910. The computer-readable medium 908 may be any suitable medium that participates in providing instructions to the processor(s) 902 for execution. For example, the computer-readable medium 908 may be non-transitory or non-volatile medium such as, a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the methods and functions of the system 102.

The system 102 may be implemented as software stored on a non-transitory processor-readable medium and executed by the processor(s) 902. For example, the computer-readable medium 908 may store an operating system 914 such as, MAC OS, MS WINDOWS, UNIX, or

LINUX, and code, for the system 102. The operating system 914 may be multi-user, multiprocessing, multitasking, multithreading, real-time, and the like. For example, during runtime, the operating system 914 is running and the code for the system 102 is executed by the processor(s) 902.

The computer system 900 may include a data storage 916, which may include non-volatile data storage. The data storage 916 stores any data used or generated by the system 102.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an A SIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 902 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
receiving, by one or more processors of at least one computing device, an input sales order;
preprocessing, by the one or more processors, the input sales order for processing using one or more pretrained Generative Artificial Intelligence (Gen AI) models;
identifying, by the one or more processors, a plurality of tokens from the preprocessed input sales order using the one or more pretrained Gen AI models;
performing, by the one or more processors, word formulation and word identification by extracting characters from the preprocessed input sales order using the one or more pretrained Gen AI models, wherein the one or more pretrained Gen AI models are trained for handwritten character identification and phonetic character identification; and
extracting, by the one or more processors, details from the preprocessed input sales order based on the plurality of tokens, and results of the performed word formulation and word identification.

2. The computer-implemented method of claim 1, wherein the input sales order is received as a voice order, and wherein preprocessing the input sales order comprises performing noise cancellation for the voice order.

3. The computer-implemented method of claim 1, wherein the input sales order is received as a written order, and wherein preprocessing the input sales order comprises performing image processing on an image of the written order by performing one or more of: gray scaling, rescaling, denoising, and/or normalization.

4. The computer-implemented method of claim 3, further comprising performing image classification by:
identifying, by the one or more processors, a plurality of image features from the image;
classifying, by the one or more processors, the image into one of a plurality of image quality standards based upon an overall quality score computed for the plurality of image features; and
extracting, by the one or more processors, text from the image that meets at least a specific image quality standard of the plurality of image quality standards, wherein the text is used to extract details from the input sales order.

5. The computer-implemented method of claim 4, wherein the overall quality score is computed using a weighted technique on the plurality of image features including a font color, a font size, a form color, a shading of the color of the image, a stamp, a watermark, an overlapping text, a broken character, and/or a distortion.

6. The computer-implemented method of claim 1, further comprising predicting missing data in the details extracted from the preprocessed input sales order using historical records, rule-based models, and/or machine-learning techniques.

7. The computer-implemented method of claim 1, further comprising predicting demand and obsolescence for one or more of: a short-term planning, a mid-term planning, and/or a long-term planning, and generating recommendations for an inventory level.

8. A system comprising:
at least one memory configured to store machine-executable instructions; and
at least one processor communicatively coupled with the at least one memory, and configured to execute the machine-executable instructions to perform operations comprising:
receiving an input sales order;
preprocessing the input sales order for processing using one or more pretrained Generative Artificial Intelligence (Gen AI) models;
identifying a plurality of tokens from the preprocessed input sales order using the one or more pretrained Gen AI models;
performing word formulation and word identification by extracting characters from the preprocessed input sales order using the one or more pretrained Gen AI models, wherein the one or more pretrained Gen AI models are trained for handwritten character identification and phonetic character identification; and
extracting details from the preprocessed input sales order based on the plurality of tokens, and results of the performed word formulation and word identification.

9. The system of claim 8, wherein the input sales order is received as a voice order, and wherein preprocessing the input sales order comprises performing noise cancellation for the voice order.

10. The system of claim 8, wherein the input sales order is received as a written order, and wherein preprocessing the input sales order comprises performing image processing on an image of the written order by performing one or more of: gray scaling, rescaling, denoising, and/or normalization.

11. The system of claim 10, wherein the operations further comprise performing image classification by:
identifying a plurality of image features from the image;
classifying the image into one of a plurality of image quality standards based upon an overall quality score computed for the plurality of image features; and
extracting text from the image that meets at least a specific image quality standard of the plurality of image quality standards, wherein the text is used to extract details from the input sales order.

12. The system of claim 11, wherein the overall quality score is computed using a weighted technique on the plurality of image features including a font color, a font size, a form color, a shading of the color of the image, a stamp, a watermark, an overlapping text, a broken character, and/or a distortion.

13. The system of claim 8, wherein the operations further comprise predicting missing data in the extracted details from the preprocessed input sales order using historical records, rule-based models, and/or machine-learning techniques.

14. The system of claim 8, wherein the operations further comprise predicting demand and obsolescence for one or more of: a short-term planning, a mid-term planning, and/or a long-term planning, and generating recommendations for an inventory level.

15. At least one non-transitory computer-readable medium (CRM) having machine-executable instructions stored thereon, which, when executed by at least one processor of at least one computing device, cause the at least one computing device to perform operations comprising:
receiving an input sales order;
preprocessing the input sales order for processing using one or more pretrained Generative Artificial Intelligence (Gen AI) models;
identifying a plurality of tokens from the preprocessed input sales order using the one or more pretrained Gen AI models;
performing word identification and word formulation by extracting characters from the preprocessed input sales order using the one or more pretrained Gen AI models, wherein the one or more pretrained Gen AI models are trained for handwritten character identification and phonetic character identification; and
extracting details from the preprocessed input sales order based on the plurality of tokens, and results of the performed word formulation and word identification.

16. The at least one non-transitory CRM of claim 15, wherein the input sales order is received as a voice order, and wherein preprocessing the input sales order comprises performing noise cancellation for the voice order.

17. The at least one non-transitory CRM of claim 15, wherein the input sales order is received as a written order, and wherein preprocessing the input sales order comprises performing image processing on an image of the written order by performing one or more of: gray scaling, rescaling, denoising, and/or normalization.

18. The at least one non-transitory CRM of claim 17, wherein the operations further comprise performing image classification by:
identifying a plurality of image features from the image;
classifying the image into one of a plurality of image quality standards based upon an overall quality score computed for the plurality of image features; and
extracting text from the image that meets at least a specific image quality standard of the plurality of image quality standards, wherein the text is used to extract details from the input sales order,
wherein the overall quality score is computed using a weighted technique on the plurality of image features including a font color, a font size, a form color, a shading of the color of the image, a stamp, a watermark, an overlapping text, a broken character, and/or a distortion.

19. The at least one non-transitory CRM of claim 15, wherein the operations further comprise predicting missing data in the extracted details from the preprocessed input sales order using historical records, rule-based models, and/or machine-learning techniques.

20. The at least one non-transitory CRM of claim 15, wherein the operations further comprise predicting demand and obsolescence for one or more of: a short-term planning, a mid-term planning, and/or a long-term planning, and generating recommendations for an inventory level.
